(19) United States
(12) Patent Application Publication
(10) Pub. No.: US 2013/0092083 A1
(43) Pub. Date: Apr. 18, 2013

(54) PHOTORESIST COATER CARRYING SYSTEM AND PHOTORESIST COATER HAVING THE SAME

(71) Applicant: Chih-hao Chang, Shenzhen (CN)

(72) Inventor: Chih-hao Chang, Shenzhen (CN)

(73) Assignee: SHENZHEN CHINA STAR OPTOELECTRONICS TECHNOLOGY CO., LTD., Shenzhen (CN)

(21) Appl. No.: 13/375,459

(22) PCT Filed: Oct. 13, 2011
(86) PCT No.: PCT/CN2011/080746

§ 371 Date: Nov. 30, 2011

(30) Foreign Application Priority Data
Oct. 12, 2011 (CN) 201120387170.1

(51) Int. Cl. B05C 13/00

(52) U.S. Cl. 118/663; 118/708

(57) ABSTRACT

The present invention relates to a photoresist coater, which includes a receiving space consisting a top slab and a bottom slab, supporting pins and a carrying tray disposed in the receiving space. The supporting pins are coupled to the carrying tray. The photoresist coater further includes an adjustment mechanism disposed in the receiving space for automatically adjusting a height of the carrying tray. The adjustment mechanism is coupled to the carrying tray. The present invention further relates to a photoresist coater carrying system. The carrying system and the corresponding photoresist coater have a simpler way of operation and higher adjustment accuracy.

### FIELD OF THE INVENTION

The present invention relates to a photoresist coater carrying system, and especially to a photoresist coater carrying system and a corresponding photoresist coater utilizing a vacuum pump for exhaustion.

### BACKGROUND OF THE INVENTION

A MURA (a phenomenon where a photoresist layer on a glass substrate has an uneven color) often occurs in manufacturing processes of thin film transistor-liquid crystal display (TFT-LCD). In a color filter (CF) process, a photoresist coater is a main production machine. The MURA can easily occur on a surface of the glass substrate when a vacuum pump is used for exhaustion during operating processes of the photoresist coater, the MURA due to bubbles generated by the vacuum pump is particularly serious.

The reason why the bubbles generated by the vacuum pump results in the MURA is that pigments, solvents, and adhesives which are contained in the photoresist are at an unstable state after the photoresist is coated on the glass substrate by a nozzle. During the exhaust process of the vacuum pump, a negative pressure is formed in the receiving space inside the photoresist coater through exhausting operation of the vacuum pump, and the solvents in the photoresist on the glass substrate are taken away by the formed negative pressure airflow. An intensity of the airflow at the moment that the negative pressure is formed is often the key for the vacuum pump to cause the MURA.

As shown in FIG. 1, the photoresist coater includes a pump 100, an aspirating valve 190, supporting pins 120, a carrying tray 130, a top slab 140 and a bottom slab 150. When using the photoresist coater, the top slab 140 is opened, and the glass substrate 110 coated with the photoresist is placed on the supporting pins 120, then the top slab 140 and the bottom slab 150 are closed to form a receiving space. The aspirating valve 190 is opened for an exhausting operation, and the pump 100 starts to execute the exhausting operation to the receiving space. Currently, bolsters 160 are usually employed to raise the glass substrate 110 for reducing a distance between the glass substrate 110 and the top slab 140, thereby reducing the airflow of the negative pressure to weaken or eliminate the generation of the MURA. However, there are following shortcomings in using the bolsters 160.

1. Raising operation can be performed only after the photoresist coater to stop working completely.

2. An operator must enter the receiving space of the photoresist coater to perform the raising operation, and dust particles on the operator are brought into the machine, which causes a product yield to be affected.

3. In executing the raising operation, the supporting pins 120, which support the glass substrate 110, may be moved from original positions. Thus, after coating the photoresist on the glass substrate 110, stresses in the supporting positions of the supporting pins 120 under the glass substrate 110 are changed. In exhausting operation of the pump 100, the glass substrate 110 has a deformation which causes that the solvents of the photoresist on the glass substrate 110 are unevenly taken away by the negative pressure, resulting in the MURA being easily formed.

4. The operator can not accurately set the distance between the glass substrate 110 and the top slab 140 through the bolsters.

Therefore, there is a significant need to provide a photoresist coater carrying system and a corresponding photoresist coater for solving the problem existing in the prior art.

### SUMMARY OF THE INVENTION

Technical problems which the present invention need to solve are that the easily formed MURA, a complex operation method, and a low accuracy in a carrying system of the photoresist coater and the corresponding photoresist coater in the prior art. An objective of the present invention is to provide a photoresist coater carrying system and a corresponding photoresist coater for automatically adjusting the distance between the glass substrate and the top slab in order to weaken or eliminate the MURA caused by the vacuum pump. The carrying system of the photoresist coater and the corresponding photoresist coater can have a simpler way of operation and a high accuracy adjustment.

The technical solution of this invention is implemented as follows.

A photoresist coater carrying system constructed in the present invention includes a carrying tray and an adjustment mechanism for automatically adjusting a height of the carrying tray, where the adjustment mechanism is coupled to the carrying tray. The adjustment mechanism includes a servomotor, a lead screw, and a connector. One end of the lead screw is coupled to the servomotor, and an opposite end of the lead screw is coupled to the carrying tray via the connector. The photoresist coater carrying system further includes a control module for controlling an output of the servomotor, in which the control module is coupled to the servomotor. The servomotor includes a feedback unit for giving a feedback from the output of the servomotor to the control module. The servomotor is a brush motor or a brushless motor, and the servomotor is an AC motor or a DC motor.

A photoresist coater carrying system constructed in the present invention includes a carrying tray and an adjustment mechanism for automatically adjusting a height of the carrying tray, where the adjustment mechanism is coupled to the carrying tray.

In the carrying system of the photoresist coater of the present invention, the adjustment mechanism comprises a servomotor, a lead screw and a connector, one end of the lead screw coupled to the servomotor, an opposite end of the lead screw coupled to the carrying tray via the connector.

In the carrying system of the photoresist coater of the present invention, the photoresist coater carrying system further comprises a control module for controlling an output of the servomotor, the control module coupled to the servomotor.

In the carrying system of the photoresist coater of the present invention, the servomotor comprises a feedback unit for giving a feedback from the output of the servomotor to the control module, in which the feedback unit is coupled to the control module.

In the carrying system of the photoresist coater of the present invention, the servomotor is a brush motor or a brushless motor.

In the carrying system of the photoresist coater of the present invention, the servomotor is an AC motor or a DC motor.

The present invention further relates to a photoresist coater. The photoresist coater includes a receiving space consisting of a top slab and a bottom slab, a supporting pins and a carrying tray disposed in the receiving space, where the supporting pins are disposed on the carrying tray. The photoresist coater further includes an adjustment mechanism disposed in the receiving space for automatically adjusting a height of the carrying tray. The adjustment mechanism is coupled to the carrying tray.

In the photoresist coater of the present invention, the adjustment mechanism comprises a servomotor, a lead screw and a connector, one end of the lead screw coupled to the servomotor, an opposite end of the lead screw coupled to the carrying tray via the connector.

In the photoresist coater of the present invention, the photoresist coater further comprises a control module for controlling an output of the servomotor, the control module coupled to the servomotor.

In the photoresist coater of the present invention, the servomotor comprises a feedback unit for giving a feedback from the output of the servomotor to the control module, in which the feedback unit is coupled to the control module.

In the photoresist coater of the present invention, the servomotor is a brush motor or a brushless motor.

In the photoresist coater of the present invention, the servomotor is an AC motor or a DC motor.

The advantageous effects of the photoresist coater carrying system and the corresponding photoresist coater of the present invention lie in: the distance between the glass substrate and the top slab can be adjusted automatically through the adjustment mechanism with a simpler way of operation and a high accuracy adjustment. The shortcomings of the easily formed MURA, the complex operation method, and the low accuracy in a carrying system of the photoresist coater and the corresponding photoresist coater in the prior art can be avoid.

### DESCRIPTION OF THE DRAWINGS

FIG. 1 is a schematic drawing illustrating a photoresist coater in the prior art;

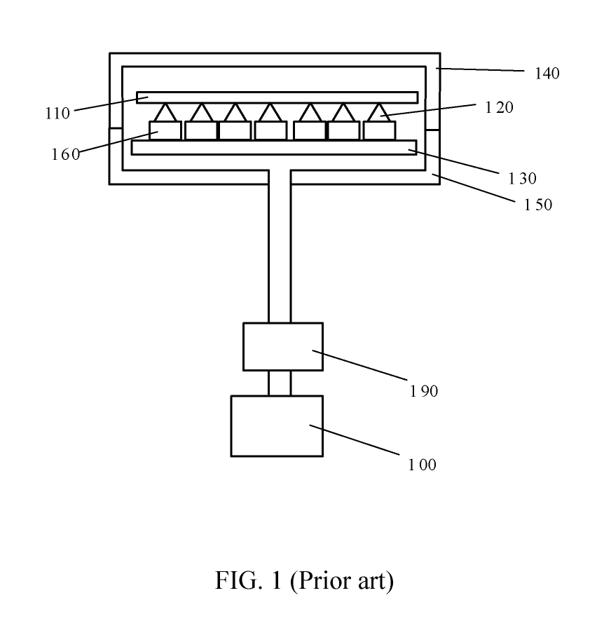

FIG. 2 is a block diagram illustrating a photoresist coater carrying system according to one preferred embodiment of the present invention; and

FIG. 3 is a schematic drawing illustrating a photoresist coater according to one preferred embodiment of the present invention.

### DETAILED DESCRIPTION OF THE PREFERRED EMBODIMENTS

The preferred embodiment of the invention will be described in detail accompanying with the drawings.

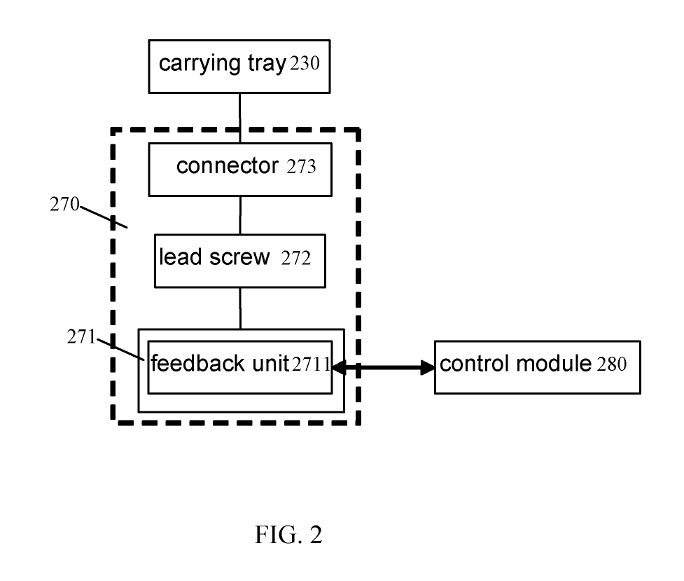

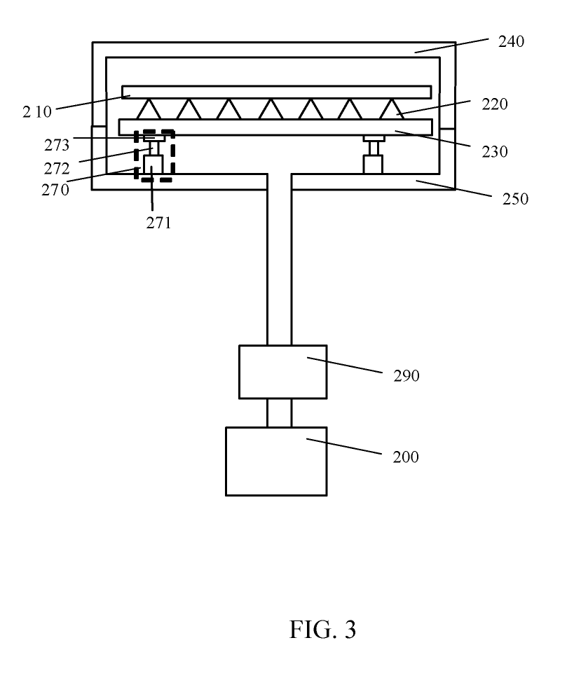

FIG. 2 is a block diagram illustrating a photoresist coater carrying system according to one preferred embodiment of the present invention, and FIG. 3 is a schematic drawing illustrating a photoresist coater according to one preferred embodiment of the present invention. In FIG. 2 and FIG. 3, the photoresist coater carrying system includes a carrying tray 230 and an adjustment mechanism 270. The adjustment mechanism 270 is used for automatically adjusting a height of the carrying tray 230. The adjustment mechanism 270 is coupled to the carrying tray 230.

The photoresist coater carrying system of the present invention realizes the automatic adjustment of the carrying tray 230 through the adjustment mechanism 270, so that the distance between the top slab 240 of the photoresist coater and the glass substrate 210 waiting for coating the photoresist can conveniently be adjusted. When using the pump 200 to vacuumize the receiving space inside the photoresist coater, the distance between the top slab 240 and the glass substrate 210 can reduced through the adjustment mechanism 270, thereby decreasing the airflow of the negative pressure to weaken or eliminate the MURA caused by the exhausting operation of the pump 200. When performing the coating process in the photoresist coater, the distance between the top slab 240 and the glass substrate 210 can increased through the adjustment mechanism 270 for facilitating the photoresist coating process. Because the distance between the top slab 240 and the glass substrate 210 is adjusted automatically by the adjustment mechanism 270 without the operator to execute the raising operation, the pollution of dust particles the MURA caused by the moved supporting pins 220 do not occur. In comparison with the manual operation, the adjustment mechanism 270 can more accurately set the distance between the top slab 240 and the glass substrate 210.

In FIG. 3 that is a schematic drawing illustrating a photoresist coater according to one preferred embodiment of the present invention, the adjustment mechanism 270 comprises servomotors 271, lead screws 272, and connectors 273. One end of the lead screw 272 is coupled to the servomotor 271, and an opposite end of lead screw 272 is coupled to the carrying tray 230 via the connector 273.

The adjustment mechanism 270 of the present invention is realized by the servomotor 271. One end of the lead screw 271 is coupled to the servomotor 271, and an opposite end of the lead screw 272 is coupled to the connector 273. The connector 273 is fixedly coupled to the carrying tray 230. The servomotor 271 receives an electrical signal and converts into an angular displacement or an angular velocity output of a motor axis. The angular displacement or the angular velocity output of the motor axis is transformed into a vertical displacement of the connector 273 through an isometric screw thread of the lead screw 272, thereby realizing the vertical position adjustment of the carrying tray 230. The servomotor 271 marks the position by a pulse. When the servomotor 271 receives a pulse, it rotates through an angle corresponding to the pulse, thereby realizing the displacement. Accordingly, the rotation angle of the servomotor 271 can be precisely controlled, thereby achieving the precise positioning of the carrying tray 230. Certainly, other devices or equipments for automatically adjusting the height of the carrying tray 230 can be employed as the adjustment mechanism 270.

In FIG. 2 that is a block diagram illustrating a photoresist coater carrying system according to one preferred embodiment of the present invention, the photoresist coater carrying system further includes a control module 280. The control module 280 is utilized to control the output of the servomotor 271, and the control module 280 is coupled to the servomotor 271. The servomotor 271 includes a feedback unit 2711. The feedback unit 2711 is utilized to give a feedback from the output of the servomotor 271 to the control module 280.

The feedback unit 2711 of the servomotor 271 is capable of dispatching pluses. Specifically, as every angle the servomotor 271 rotates, the feedback unit 2711 dispatches a corresponding number of the pluses, which responds to the pluses the control module 280 dispatches. The control module 280 dispatches a number of the pluses to the servomotor 271 and receives a number of the pluses from the feedback unit 2711 at the same time. Accordingly, the rotation of the servomotor 271 can be accurately controlled in accordance with the numbers of the received pluses and the dispatched pluses. If the number of the received pluses is less than the number of the dispatched pluses, the number of the dispatched pulses is increased correspondingly for the next dispatching. If the number of the received pluses is more than the number of the dispatched pluses, the number of the dispatched pulses is decreased correspondingly for the next dispatching, thereby realizing the precise positioning.

In the photoresist coater carrying system of the preferred embodiment of the present invention, the servomotor 271 is a brush motor or a brushless motor, and the servomotor 271 is an AC motor or a DC motor.

The brush motor has the advantages of low cost, a simple structure, large starting torque, wide speed range, and easy controlling, but it has the disadvantages of requiring maintenance, inconvenient maintenance (brush replacing), electromagnetic interference easily occurred, and high environmental requirement. Thus, it can be utilized for cost-sensitive general industrials and civil applications. The brushless motor has the advantages of small size, light weight, large output, fast response, high speed, small inertia, smooth rotation, stable torque, easy to intelligent, flexible way to electronic commutation with a square wave or a sine wave commutation, motor maintenance free, high efficiency, low operating temperature, small electromagnetic radiation, long life, and various-environments usage, but it has the disadvantages of complex controlling and high cost. Meanwhile, users can choose the AC motor or the DC motor to as a servomotor 271 according to the specific desires.

The present invention further relates to a photoresist coater. FIG. 2 is a block diagram illustrating a photoresist coater carrying system according to one preferred embodiment of the present invention, and FIG. 3 is a schematic drawing illustrating a photoresist coater according to one preferred embodiment of the present invention. In FIG. 2 and FIG. 3, the photoresist coater includes: a receiving space consisting of a top slab 240 and a bottom slab 250, a supporting pins 220 and a carrying tray 230 disposed in the receiving space, in which the supporting pins 220 are disposed on the carrying tray 230. The photoresist coater further includes an adjustment mechanism 270 disposed in the receiving space for automatically adjusting a height of the carrying tray 230. The adjustment mechanism 270 is coupled to the carrying tray 230.

As shown in FIG. 3, the supporting pins 220 and the carrying tray 230 are sequentially disposed in the receiving space from top to bottom. The adjustment mechanism 270 which is disposed below the carrying tray 230 is coupled to the carrying tray 230. The photoresist coater of the present invention realizes the automatic adjustment of the carrying tray 230 through the adjustment mechanism 270, so that the distance between the top slab 240 of the photoresist coater and the glass substrate 210 waiting for coating the photoresist can conveniently be adjusted. When using the photoresist coater, the top slab 240 is unclosed, and the glass substrate 210 is placed on the supporting pins 220, and then the top slab 240 and the bottom slab 250 are enclosed to form a receiving space. In the exhausting operation, the aspirating valve 290 is turned on, and the pump 200 begins to vaccumize the receiving space inside the photoresist coater. The distance between the top slab 240 and the glass substrate 210 can reduced through the adjustment mechanism 270, thereby decreasing the airflow of the negative pressure to weaken or eliminate the MURA caused by the exhausting operation of the pump 200. When performing the coating process in the photoresist coater, the distance between the top slab 240 and the glass substrate 210 can increased through the adjustment mechanism 270 for facilitating the photoresist coating process. Because the distance between the top slab 240 and the glass substrate 210 is adjusted automatically by the adjustment mechanism 270 without the operator to execute the raising operation, the pollution of dust particles the MURA caused by the moved supporting pins 220 do not occur. In comparison with the manual operation, the adjustment mechanism 270 can more accurately set the distance between the top slab 240 and the glass substrate 210.

In FIG. 3 that is a schematic drawing illustrating a photoresist coater according to one preferred embodiment of the present invention, The adjustment mechanism 270 comprises servomotors 271, lead screws 272, and connectors 273. One end of the lead screw 272 is coupled to the servomotor 271, and an opposite end of lead screw 272 is coupled to the carrying tray 230 via the connector 273.

The adjustment mechanism 270 of the present invention is realized by the servomotor 271. One end of the lead screw 271 is coupled to the servomotor 271, and an opposite end of the lead screw 272 is coupled to the connector 273. The connector 273 is fixedly coupled to the carrying tray 230. The servomotor 271 receives an electrical signal and converts into an angular displacement or an angular velocity output of a motor axis. The angular displacement or the angular velocity output of the motor axis is transformed into a vertical displacement of the connector 273 through an isometric screw thread of the lead screw 272, thereby realizing the vertical position adjustment of the carrying tray 230. The servomotor 271 marks the position by a pulse. When the servomotor 271 receives a pulse, it rotates through an angle corresponding to the pulse, thereby realizing the displacement. Accordingly, the rotation angle of the servomotor 271 can be precisely controlled, thereby achieving the precise positioning of the carrying tray 230. Certainly, other devices or equipments for automatically adjusting the height of the carrying tray 230 can be employed as the adjustment mechanism 270.

In the photoresist coater of the preferred embodiment of the present invention, the photoresist coater carrying system further includes a control module 280. The control module 280 is utilized to control the output of the servomotor 271, and the control module 280 is coupled to the servomotor 271. The servomotor 271 includes a feedback unit 2711. The feedback unit 2711 is utilized to give a feedback from the output of the servomotor 271 to the control module 280.

The feedback unit 2711 of the servomotor 271 is capable of dispatching pluses. Specifically, as every angle the servomotor 271 rotates, the feedback unit 2711 dispatches a corresponding number of the pluses, which responds to the pluses the control module 280 dispatches. The control module 280 dispatches a number of the pluses to the servomotor 271 and receives a number of the pluses from the feedback unit 2711 at the same time. Accordingly, the rotation of the servomotor 271 can be accurately controlled in accordance with the numbers of the received pluses and the dispatched pluses. If the number of the received pluses is less than the number of the dispatched pluses, the number of the dispatched pulses is increased correspondingly for the next dispatching. If the number of the received pluses is more than the number of the dispatched pluses, the number of the dispatched pulses is decreased correspondingly for the next dispatching, thereby realizing the precise positioning.

In the photoresist coater of the preferred embodiment of the present invention, the servomotor 271 is a brush motor or a brushless motor, and the servomotor 271 is an AC motor or a DC motor.

The brush motor has the advantages of low cost, a simple structure, large starting torque, wide speed range, and easy controlling, but it has the disadvantages of requiring maintenance, inconvenient maintenance (brush replacing), electromagnetic interference easily occurred, and high environmental requirement. Thus, it can be utilized for cost-sensitive general industrials and civil applications. The brushless motor has the advantages of small size, light weight, large output, fast response, high speed, small inertia, smooth rotation, stable torque, easy to intelligent, flexible way to electronic commutation with a square wave or a sine wave commutation, motor maintenance free, high efficiency, low operating temperature, small electromagnetic radiation, long life, and various-environments usage, but it has the disadvantages of complex controlling and high cost. Meanwhile, users can choose the AC motor or the DC motor to as a servomotor 271 according to the specific desires.

The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A photoresist coater carrying system, characterized in that, comprising a carrying tray and an adjustment mechanism for automatically adjusting a height of the carrying tray, the adjustment mechanism is coupled to the carrying tray;
the adjustment mechanism comprising a servomotor, a lead screw and a connector, one end of the lead screw being coupled to the servomotor, an opposite end of the lead screw being coupled to the carrying tray via the connector;
the photoresist coater carrying system further comprising a control module for controlling an output of the servomotor, the control module being coupled to the servomotor;
the servomotor comprising a feedback unit for feeding the output of the servomotor back to the control module;
the servomotor being a brush motor or a brushless motor; and the servomotor being an AC motor or a DC motor.

2. A photoresist coater carrying system, characterized in that, comprising a carrying tray and an adjustment mechanism for automatically adjusting a height of the carrying tray, the adjustment mechanism being coupled to the carrying tray.

3. The photoresist coater carrying system according to claim 2, characterized in that, the adjustment mechanism comprises a servomotor, a lead screw and a connector, one end of the lead screw is coupled to the servomotor, an opposite end of the lead screw is coupled to the carrying tray via the connector.

4. The photoresist coater carrying system according to claim 3, characterized in that, the photoresist coater carrying system further comprises a control module for controlling an output of the servomotor, the control module is coupled to the servomotor.

5. The photoresist coater carrying system according to claim 4, characterized in that, the servomotor comprises a feedback unit for feeding the output of the servomotor back to the control module.

6. The photoresist coater carrying system according to claim 3, characterized in that, the servomotor is a brush motor or a brushless motor.

7. The photoresist coater carrying system according to claim 3, characterized in that, the servomotor is an AC motor or a DC motor.

8. The photoresist coater carrying system according to claim 4, characterized in that, the servomotor is a brush motor or a brushless motor; and the servomotor is an AC motor or a DC motor.

9. A photoresist coater, comprising: a receiving space forming by a top slab and a bottom slab, supporting pins and a carrying tray disposed in the receiving space, the supporting pins being disposed on the carrying tray, characterized in that, the photoresist coater further comprises an adjustment mechanism which is disposed in the receiving space for automatically adjusting a height of the carrying tray, the adjustment mechanism is coupled to the carrying tray.

10. The photoresist coater according to claim 9, characterized in that, the adjustment mechanism comprises a servomotor, a lead screw and a connector, one end of the lead screw is coupled to the servomotor, an opposite end of the lead screw is coupled to the carrying tray via the connector.

11. The photoresist coater according to claim 10, characterized in that, the photoresist coater further comprises a control module for controlling an output of the servomotor, the control module is coupled to the servomotor.

12. The photoresist coater according to claim 11, characterized in that, the servomotor comprises a feedback unit for giving a feedback from the output of the servomotor to the control module, the feedback unit is coupled to the control module.

13. The photoresist coater according to claim 10, characterized in that, the servomotor is a brush motor or a brushless motor.

14. The photoresist coater according to claim 10, characterized in that, the servomotor is an AC motor or a DC motor.

15. The photoresist coater according to claim 11, characterized in that, the servomotor is a brush motor or a brushless motor; and the servomotor is an AC motor or a DC motor.
